(19) United States
(12) Patent Application Publication
(10) Pub. No.: US 2006/0052251 A1
(43) Pub. Date: Mar. 9, 2006

(54) Time release multisource marker and method of deployment

(76) Inventors: David King Anderson, Houston, TX (US); Royce Beck Ferguson, Addison, TX (US)

Correspondence Address: George R. Schultz;Schultz & Associates, P.C., One Lincoln Centre, 5400 LBJ Freewary, Suite 525, Dallas, TX, 75240, US

(21) Appl. No.: 10/936,968

(22) Filed: Sep. 9, 2004

(51) Int. Cl. C09K 8/02; C09K 8/03

(52) U.S. Cl. 507/103

(57) ABSTRACT

The present invention provides time released markers for use with single reservoir and commingled wells. The invention accomplishes the time release of markers by coating or encapsulating marker particles or by coating a proppant which has been saturated with a marker. After coating or encapsulation, the marker is injected into a well as is known in the art. The marker remains in the well. The marker is released after an elapsed of time. The elapsed time can be in a wide range. After the elapsed time, production is taken from the well and tested for the presence of the marker. Various types of known analyses can be performed to test for the presence and concentration of the marker in the production fluid. The concentration of the marker in the production fluid allows the apportioning of production from the reservoir. In addition, different markers may be added to each zone within a reservoir where each marker has a different elapsed time increment. The zones can be any different layer or area in the reservoir such as different strata or layer of rock, limestone or sand. Differing marker combinations allow contribution from different zones to be monitored over an extended time.

### FIELD OF THE INVENTION

The present invention relates to chemically marking a reservoir in an oil and gas well and more particularly, to a method for marking a reservoir during the fracturing, gravel packing or acidizing phase of well completion and still more particularly, to a method for using a marker combined with proppant to chemically mark a reservoir wherein the marker may be released from its association with the proppant at a delayed time and release rate.

### BACKGROUND OF THE INVENTION

In order to increase the economics of oil well productions, many wells in the United States today use hydraulic fracturing to draw hydrocarbons through subterranean formations called reservoirs. Fracturing is a method of stimulating production by opening new flow channels in the reservoir surrounding a production well. During fracturing, high viscosity fracturing fluid is pumped into a reservoir under pressure high enough to cause the reservoir to crack open, forming passages through which hydrocarbons can flow into a wellbore.

Fracturing fluid is a high viscosity fluid, such as distillate, diesel fuel, crude oil, kerosene, water, alcohols, hydrocarbons, dilute hydrochloric acid, or some other type of acid. The fracturing fluid carries propping agents, commonly known in the art as “proppant,” which is deposited in the newly created fractures to keep the fractures from closing. After the fracturing fluid has been pumped into the reservoir, the fractures formed, and the proppant deposited, it is generally desirable to convert the high viscosity fracturing fluid into a low viscosity fluid to allow the fluid to be removed from the reservoir. This reduction of the viscosity of the fracturing fluid is commonly referred to as “breaking” the fracturing fluid and is typically carried out by the addition of a viscosity reducing agent, commonly called a breaker.

After breaking and removing the fracturing fluid from the reservoir, the proppant is left behind to hold open the newly created fractures. Examples of typical proppants are sand grains, aluminum pellets, walnut shells, or other similar materials. Often it is desirable to know the amount of proppant deposited in the reservoir to determine the extent of the fracturing over a comparatively long period of time or the contribution of the reservoir that has been fractured.

In order to mark reservoir fluids, several types of molecular markers are available. Radioactive particles may be used as can acids and salts with various easily identifiable characteristics. Examples of acids and salts are flourobenzene acids and flourobenzoic salts. Other useful markers include those whose molecular weight has been artificially altered to accommodate analysis. Examples of these are carbon-13, fluorin-19 and nitrogen-15. Each of these types of markers is well known in the art.

Besides stimulation, other methods of increasing oil production exist in order to improve the economics of a well. “Commingling” is one such method.

In a well with multiple reservoirs, commingling is producing from two or more reservoirs at the same time. Commingling is economically advantageous in many respects but can create the risk of loss of production through differing zonal pressure regimes. Differing zonal pressure creates differing zonal contribution to the total production.

In the prior art, the cost of determining zonal contribution can be prohibitively expensive. Zonal contribution is accomplished in the prior art using production logging tools. Production logging tools are expensive and require expertise to operate and maintain. The use of the tools is also time consuming and introduces potential problems such as broken, lost, or stuck tools and wellbore damage.

The prior art also discloses marking different zones of a reservoir with different markers. However, due to dispersion, wash out, and other phenomena, markers placed in zones decrease in concentration rapidly after injection. The rapid decrease reduces the amount of time that the markers may be useful in determining zonal contribution. The prior art provides several examples of marking various recovery fluids and proppant in order to determine zonal contribution, but does not provide a method for delaying the release, in time or rate, of a marker.

One method to monitor fracturing is described in U.S. Pat. No. 6,659,175 to Malone et al, entitled “Method for Determining the Extent of Recovery of Materials Injected into Oil Wells during Oil and Gas Exploration and Production.” Malone et al. discloses a proppant coated with a tracer. The tracer is released as soon as the proppant is injected because it is on the surface of the proppant and is directly exposed to reservoir fluids.

Another method is for tracking particulates in wells is described in U.S. Pat. No. 6,691,780 to Nguyen et al, entitled “Tracking of Particulate Flowback in Subterranean Wells.” Nguyen discloses a non-radioactive composition for tracking the transport of particulate solids during the production of hydrocarbons from a subterranean formation penetrated by a well bore. Nguyen attaches metals or bonds them onto proppant material. The metal acts as a tracer. However, there is no delay, in time or rate, in release of the tracer into the reservoir fluid. Further, analysis is performed on the recovered solids rather than the produced fluid.

U.S. Pat. No. 4,741,401 to Walles et al, entitled “Method for Treating Subterranean Formations” discloses encapsulating breaker in a material. The enclosure material is permeable to a fluid in the subterranean formation such that upon sufficient exposure to the fluid, the enclosure material ruptures releasing the breaker fluid into the formation. However, the breaker is not used for tracing purposes, is combined with proppant or a marker, and is not used to determine the extent of fracturing. Also, the release of the breaker into the reservoir fluid occurs as quickly as possible so as to not hold up production of the well.

U.S. Pat. No. 6,444,316 to Reddy et al, entitled “Encapsulated Chemicals for Use in Controlled Time Release Applications and Methods”, discloses encapsulated chemicals in well operations involving primary cementing in deep water offshore wells. The method of encapsulating the chemicals includes forming a first coating of a dry hydrophobic film forming material or a sparingly soluble material which creates a dry shield on the chemical. An additional coating of a porous cross-linked hydrophilic polymer delays release of the chemical for a period of time. However, the encapsulated chemical is not used for tracing purposes, is not combined with proppant, and is not used in relation to well fracturing.

What is needed therefore is a method allows for a marker to be released over time in one or more zones of a reservoir. What is also needed is a method to mark a proppant in such a way as to delay release, in time and rate, of the marker. Additionally, there is a need for a method to determine if one or more zones in a reservoir are contributing to production on a qualitative basis over an extended period of time.

### SUMMARY OF THE INVENTION

The present invention provides delayed release markers for use with single reservoir and commingled wells. The invention accomplishes the delayed release of markers by coating or encapsulating the markers with a coating or by coating a proppant which has a marker embedded in it.

Coating also provides the benefit of slowing the release rate of the marker. The presence of the marker can be detected for a longer period of time, extending the usefulness of the marker system.

After coating or encapsulation, the marker is injected into a well as is known in the art. The marker remains in the well. The marker is released after an elapsed period of time. The elapsed time can be in a wide range. Generally, the shortest elapsed time is about an hour and the longest time is on the order of several years. After an elapsed time, produced fluid is taken from the well and tested for the presence of the marker.

Various types of known analyses can be performed to test for the presence and concentration of the marker in the production fluid. The concentration of the marker in the production fluid allows the apportioning of production from the reservoir.

In addition, different markers may be added to each zone within a reservoir where each marker has a different elapsed time increment. The zones can be any different layer or area in the reservoir such as different strata or layer of rock, limestone or sand. Differing marker combinations allow contribution from different zones to be monitored over an extended time.

### DETAILED DESCRIPTION OF THE DRAWINGS

A better understanding of the invention can be obtained from the following detailed description of exemplary embodiments as considered in conjunction with the following drawings in which:

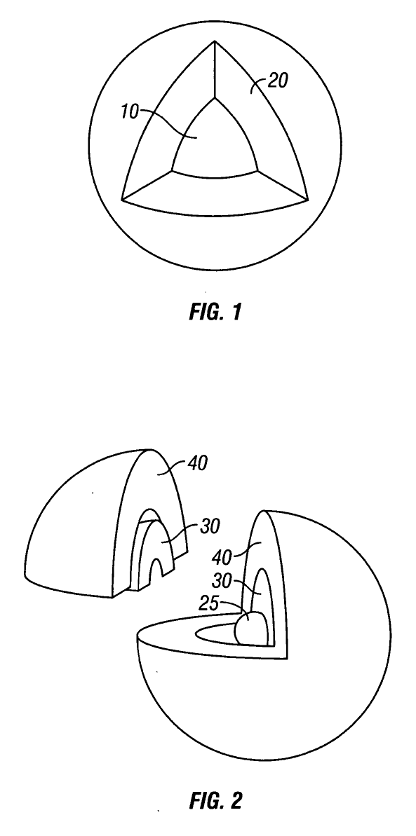

FIG. 1 is a cut-away view of a single particle of marker having a single layer coating prepared according to the method of the present invention;

FIG. 2 is a cut-away view of a single particle of marker having a multilayer coating prepared according to the method of the present invention;

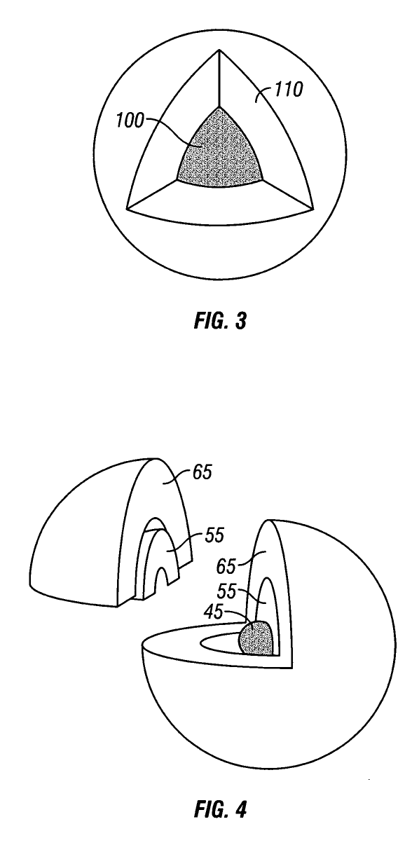

FIG. 3 depicts a cutaway view of a single particle of porous proppant saturated with a marker and having a single coating prepared according to the method of the invention;

FIG. 4 depicts a cutaway view of a single porous proppant particle saturated with a marker and having a multilayer coating prepared according to the method of the invention; and

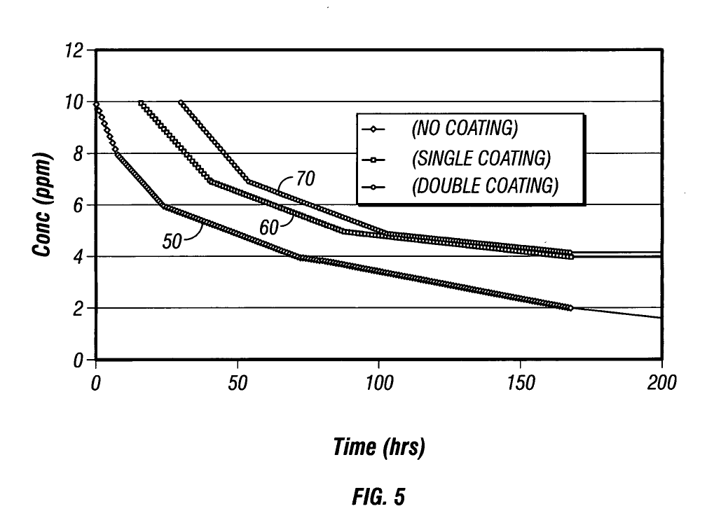

FIG. 5 depicts a graphical comparison of the relative time delay effect of coated markers according to the present invention up to 200 hours.

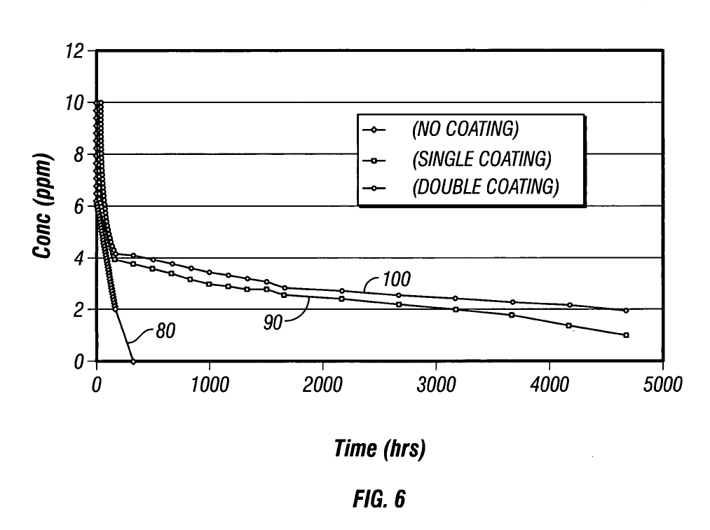

FIG. 6 depicts a graphical comparison of the relative time delay effect of coated markers according to the present invention up to 5,000 hours.

### DETAILED DESCRIPTION

The preferred embodiment of the present invention provides a method and apparatus for marking a reservoir with a coated chemical marker or with a chemical marker embedded in a coated proppant. The coated proppant is added to the reservoir during the fracturing, gravel packing or acidizing phase of well completion. The marker settles in the fractures of the reservoir during the fracturing process. The marker is released over an extended period of time. The amount of time is determined by the method used to coat the marker.

The release of the marker into the reservoir is caused by two mechanisms. First, reservoir fluid flows through the permeable coating and dissolves the marker which is then released into the reservoir. The second mechanism is the crushing or rupturing of the coating placed around the marker. The physical pressure placed on the coating by the geologic formation of the reservoir can crush the coating allowing reservoir fluids to immediately contact the marker and release it into the surrounding reservoir fluid. The coating around the marker can also be ruptured by internal gas pressure on the coating created by the materials used for the coating or chemicals added to the marker.

Many types of markers will work equally well in practice of the invention. Selection of the marker is based on several factors. Examples of these factors are reservoir characteristics such as reservoir temperature, water saturation pressure, and ph levels; the method desired to deliver the marker (such as being pumped as a proppant during gravel packing or carried into the wellbore as a proppant screen); and cost factors impacted by the total amount of marker needed, the type of marker used and the analytical method required to qualify and/or quantify the marker. These factors and others are known in the art.

For example, trifluorobenzene acids and fluorobenzoate salts are good markers because of their water solubility, non-reactance with reservoir fluids, and relatively low cost. Other examples of chemicals that may be used as chemical markers include, but are not limited to, triflourobenzene, rhodamine, flourobenzoic acids, polynuclear aromatic hydrocarbons and halogenated hydrocarbons such as 1,2-diphenylbenzene; 1,4-diphenylbenzene, triphenylmethane, 1,3,5-triphenylbenzene, 1,1,2-triphenylethylene; tetraphenylethylene, 1,2,3,4-tetrahydrocarbazole, 1,3-diphcnylacetone, 2-chlorobenzophenone; 4,4′-dichlorobenzophenone, 4-benzoylphenone, 4-bromobenzophenone, 4-methoxybenzophenone, 4-methylbenzophenone, 9-fluorenone, 1-phenylnaphthalene, 3,3 dimethoxybiphenyl, 9-phenylanthracene, and markers where the molecular weight of the molecule is artificially enhanced.

In some cases dyes and some classes of colorants make effective tracers. These include azodyes, metal complex azodyes, polymethine (cyanine) dyes, perylene dyes, coumarin dyes, xanthene dyes.

Markers where the molecular weight of the molecule is artificially enhanced are also good markers. These can be produced with stable isotopes not generally found in nature. The isotopes can be labeled with an atom in at least one specific site in the molecule. Particularly preferred are those compounds deuterated or rendered isotopic by carbon-13 or fluorine-19, nitrogen-15, oxygen-17 and oxygen-18 isotopic materials. The marker may be a non-radioactive isotope of such organic solvents as acetone, acetonitrile, benzene, bromobenzene, chlorobenzene, chloroform, cyclohexane, dichlorobenzene, trichloroethylene, diethylether, diglyme, dimethylsulfoxide, dioxane, ethanol, methanol, methylene chloride, nitrobenzene, octane, pyridine, tetrachloroethane, tetrahydrofuran, tetrametholsilane, toluene, trifluoroacetic acid, trifluoroethyl alcohol, xylene, ammonium bromide, or acetyl chloride. One particularly preferred class of organic compounds are those which have been deuterated, i.e., wherein the hydrogen atoms covalently bound to carbon atoms are replaced with deuterium atoms.

Deuteration of organic compounds can be accomplished by methods known in the art such as those disclosed in U.S. Pat Nos. 3,746,634 and 3,876,521 wherein deuteration is effected with deuterium gas in the presence of a Group VII or VIII metal catalyst at a temperature between about 100 and about 300 degrees C.

Isotopes for use in this invention may further be prepared in accordance with the prior art teachings of such materials used in the medical arts. The chemical substances may have the heavy atom in any position of the molecule. Likewise, one or more of the reactive sites of a molecule may contain a heavy atom. For example, there are thousands of permutations possible with n-octane since one or all of the hydrogen atoms of the molecule may be substituted with deuterium. Some examples of formulas are:
CH₂DCH₂CH₂CH₂CH₂CH₂CH₂CH₃;
CH₃CHDCH₂CH₂CH₂CH₂CH₂CH₃;
CH₂DCHDCH₂CH₂CH₂CH₂CH₂CH₃;
CH₂DCH₂CH₂CH₂CH₂CH₂CH₂CH₂D;
CH₂DCHDCHDCH₂CH₂CH₂CH₂CH₃;
CH₂DCHDCHDCH₂CH₂CH₂CH₂CH₂D.

In one preferred embodiment of the invention, the marker may be used in a solid particulate form. One example would be the solid particle form of fluorobenzoate salt. Of course, other examples of particulate markers can be used with equal success. Marker weights as low as 50 nanograms and as high as 1 gram may be used, although the preferred range is between 20 and 500 milligrams. In another preferred embodiment, the particulate marker is sized before use using a mesh or other methods commonly known in the art. Such meshes are readily available. One is available from Hayward Industrial Products, Inc., of Elizabeth, N.J. In another embodiment of the invention, the coated marker particles are not sifted to obtain a uniform size. The resulting random particle sizes result in an extended period of release of the marker into the reservoir fluid due to the different thicknesses of cellulosic coating covering the marker particle. The larger particles are crushed during formation closure and immediately release marker, while the smaller particles are lodged in the fracture and release over a more extended period of time.

In another embodiment of the preferred embodiment of the invention, the marker may be used to saturate a porous proppant before coating. The porous proppant may be a porous ceramic bead with a pore size of around 16/40 mesh. The mesh size of the bead may range from 10/20 to 40/70. Alternate porous proppants include diatomaceous earth having at least 35 mesh size, but preferably greater than 40 mesh and crushable walnut shells preferably being 20/30 mesh but having a range of 10/20 to 40/70 mesh. To saturate a porous proppant with a marker, the marker is first diluted, at room temperature, to between 5% and 10% concentration in deionized water.

Ceramic beads are added to the marker solution to produce a slurry. The slurry is stirred for 10-120 minutes using a paddle stirrer as known in the art. The stirred slurry is dried in a convection oven at approximately 100° C. for approximately 2 hours or until the slurry contains between about 0.1%-8% moisture with the preferred percentage being below 1%.

The marker concentration may be increased by adding additional 5% marker solution to the dried slurry. If more of the 5% marker solution is been added to the dried slurry, the slurry is again heated in a convection oven at approximately 100° C. for approximately two hours. The marker concentration may be increased up to any desired concentration by continued successive addition of the marker solution and drying steps.

Many types of coatings will work well in practice of the invention. One preferred embodiment employs liquid cellulose acetate. Other cellulosic materials such as polymers, cellulose ether, epicellulose, cellulose ester or polyvinyl alcohol may also be used with equal success. Teflon may be used in an alternate embodiment with equal success as well. An epoxy coating can also be used. For example, a two-stage epoxy such as Dow Plastics D.E.I. 331 liquid epoxy resin and D.E.R. 24 epoxy curing agent can be used with good success. This epoxy and curing agent are well known in the art and are commercially available from Ashland, Inc. located in Covington, Ky. and Dow Chemical Company located in Midland, Mich. Other coatings such as phenolic resins and hydrophilic polymers can also be used with equal success. Generally, in aqueous environments, the characteristics of the cellulosic materials should be water insolubility, but water permeability. In organic environments, the characteristics of the cellulosic materials should preferably be oil insolubility but oil permeability. The thickness of the applied coating is can vary between 0.5 and 100 microns, though a useful range is 10 to 65 microns.

To increase the rupturability of the coating, an oxidizing agent such as potassium permanganate may be added to the coating so that a gas is produced upon contact with reservoir fluids. Other suitable oxidizing agents are sodium dichromate and fluorine. The formation of the gas increases the internal pressure on the shell, thereby increasing rupturability.

In one preferred embodiment, the oxidizing agent is added to and mixed with the marker material before the marker is coated. If in particulate form, the oxidizing agent is allowed to agglomerate with the marker before coating steps are carried out. If in liquid form, the oxidizing agent is frozen or added to the marker solution and allowed to disperse evenly before further processing. The amount of oxidizing agent is dependent on the reservoir conditions and agent chosen. The more oxidizing agent that is added, the greater the internal pressure on the coating, which results in a quicker marker release time.

Any number of processes, known in the art, may be used to coat the marker particles. For example, a fluidized bed process is used to coat the marker in the preferred embodiment. U.S. Pat. Nos. 3,237,596 and 3,382,093 are descriptive of the fluidized bed processes that can be used to coat marker particles. Other processes such as acoustic levitation and phase separation may be used in the coating procedure. Another example is a stirring method whereby small batches of marker may be prepared conveniently. In the stirring method, the marker particles are mixed in a slurry with a liquid coating material at an elevated temperature for a predetermined period of time or until the slurry contains a predetermined amount of moisture. A dry powder free-flow agent may then be added to prevent agglomeration of marker particles. A variety of free flow agents are well known in the art and are available from several manufacturers. The slurry is then allowed to dry into particle form before use.

In one preferred embodiment of the invention, multiple coatings can be applied to the marker or porous proppant. The steps used to coat the marker are simply repeated starting with the dried coated marker particle or porous proppant created by previous drying steps.

### EXAMPLE 1

200 mg dry, solid particles of 2,4,5 trifluorobenzoic acid or flourobenzoate salt are sorted for particle size by mesh screens of sizes 20 to 40. These particles are fluidized in a UniGlatt fluidized bed apparatus using a Wurster column. These particles are then sprayed with a liquid cellulose acetate consisting of about 40% percent solids. A spray nozzle with level setting and air pressure of 2.7 bars combined with an exhaust filter bumping scheme of 10 seconds duration with a 2 minute interval is employed in the coating operation. The inlet temperature is 50 degrees Celsius and the feed rate about 15 milliliters (ml) per minute. The spray time is about 30 minutes. The capsules have a coating thickness which varies from 5 to 65 microns and an average coating thickness of 40 microns.

### EXAMPLE 2

A 5% solution of 2,4,5 triflourobenzoic acid in distilled water is prepared at room temperature. The 5% 2,4,5 triflourobenzoic acid or flourobenzoate salt solution is then added to ceramic beads having a mesh size of 20/40 to create a slurry. In this example, the batch size is 10 kg.

The slurry is stirred for 15 minutes using a paddle stirrer to saturate the ceramic beads with the 2,4,5 triflourobenzoic acid or flourobenzoate salt. The stirred slurry is dried in a convection oven at approximately 38° C. for 30 minutes until the slurry contains about 0.25% moisture. The marker concentration is increased from 5% to 10% by successive addition of the 5% marker solution to the dried slurry. Once the 5% marker solution has been added to the dried slurry, the slurry is again heated to obtain between about 0.1%-8% moisture.

The coatings are prepared by first combining an epoxy resin and catalyst according to the manufacturer's specifications. The catalyzed epoxy is added to the saturated proppant at a ratio of approximately 1 part epoxy to 100 parts proppant. By adding more or less epoxy, for example 1.1 parts per 100 or 0.85 parts per 100, the thickness of the coating may be altered, thereby adjusting the delay in release of the marker. The mixture is stirred using a paddle stirrer. The stirring continues for approximately 35 minutes.

500 grams of Aqua Wax, for example, a known free flow agent, is added to the mixture which is then stirred for an additional 5 minutes. The mixture is allowed to cure at room temperature producing a particle weight of approximately 100 milligrams.

### EXAMPLE 3

A 5% solution of 2,4,5 triflourobenzoic acid in distilled water is prepared at room temperature. The 5% 2,4,5 triflourobenzoic acid or flourobenzoate salt solution is then added to ceramic beads having a mesh size of 20/40 to create a slurry. In this example, the batch size is 10 kg.

The slurry is stirred for 15 minutes using a paddle stirrer to saturate the ceramic beads with the 2,4,5 triflourobenzoic acid or flourobenzoate salt. The stirred slurry is dried in a convection oven at approximately 38° C. for 30 minutes until the slurry contains about 0.25% moisture. The marker concentration is increased from 5% to 10% by successive addition of the 5% marker solution to the dried slurry. Once the 5% marker solution has been added to the dried slurry, the slurry is again heated to obtain between about 0.1%-8% moisture.

An epoxy coating and hardener are combined and mixed and added to the dried slurry. The catalyzed epoxy is added to the saturated proppant at a ratio of approximately 1 part epoxy to 100 parts proppant. These particles are fluidized in a UniGlatt fluidized bed apparatus using a Wurster column. These particles are then sprayed with a liquid cellulose acetate consisting of about 40 percent solids. A spray nozzle with level setting and air pressure of 2.7 bars combined with an exhaust filter bumping scheme of 10 seconds duration with a 2 minute interval is employed in the coating operation. The inlet temperature is 50 degrees Celsius and the feed rate about 15 milliliters (ml) per minute. The spray time is about 30 minutes. The capsules have a coating thickness which varies from 5 to 65 microns and an average coating thickness of 40 microns.

Use of the Coated Marker

Use of a marker or saturated proppant coated by the methods of the present invention can be made in the fracturing phase of well production, characterizing inner flow well paths, or other methods where time-released markers and proppants are both required are useful in well production.

For example, to apply the present invention in the fracturing phase of well production, the coated marker or coated saturated proppant is added to the fracturing fluid as known in the art and then injected into the well as known in the art. The coated marker or coated saturated proppant settles in the fractures of the reservoir during fracturing, gravel packing or acidizing phase of well production. The marker is then released according to permeation or rupturing of coating. The well is then allowed to produce and production fluid is taken in one or more samples as known in the art. The production fluid is analyzed for the presence and/or concentration of the marker over time.

Markers prepared according to the methods of the current invention are especially useful in determining zonal contribution in commingled reservoirs.

To apply the present invention to a commingled reservoir, a different marker is used in the preparation of a separate batch of proppant for each reservoir. During initial production, a single unique marker batch is deployed in each commingled reservoir. The reservoirs are then allowed to produce at the same time. A sample of production fluid is then taken as known in the art and analyzed to determine the presence and concentration of each unique marker from each commingled reservoir. For example, if a marker is not present in the production fluid, then the corresponding reservoir has not contributed to the production fluid. If a marker is present, then based on the relative concentration of each marker, an estimate of each reservoir's contribution to the overall production fluid may be determined as is known in the art.

FIG. 1 is a cutaway view of a single particle of encapsulated marker prepared according to one method of the invention. FIG. 1 shows the cellulosic coating 20 surrounding the marker particle 10. Coating 20 is permeable to reservoir fluids. Therefore, reservoir fluids flow through coating 20 reaching marker 10 and dissolving it, resulting in release of the marker into the reservoir fluid. Coating 20 in the preferred embodiment is between 10 microns and 65 microns thick depending on the overall particle size.

FIG. 2 is a graphic representation of a single coated marker particle with multiple layers of encapsulation. FIG. 2 shows marker particle 25 covered by first coating 30 and second coating 40. Multiple coatings are applied to increase the delay in release time of the marker.

FIG. 3 is a cut away view of a single particle of porous proppant saturated with marker. FIG. 3 shows an epoxy coating 110 surrounding a saturated proppant particle 100. The porous proppant 100 is exposed by degradation of the two part epoxy coating caused by friction from fluid flow over the coating in the reservoir. The marker is released after the degradation of the epoxy coating by permeation of the porous proppant with reservoir fluid and dispersion of the marker therein.

FIG. 4 is a graphic representation of a single particle of porous proppant saturated with marker with multiple layers of encapsulation. FIG. 4 shows marker particle 45 covered by first coating 55 and second coating 65. Multiple coatings are applied to increase the delay in release time of the marker.

FIG. 5 is a graphic representation of the delayed decrease in marker concentration versus time for the preferred embodiments of the invention shown for the time between 0 and 200 hours. Curve 50 shows a relative marker decrease for an uncoated marker particle as known in the prior art. Curve 60 shows the relative marker concentration decrease for a single coated particle prepared pursuant to the methods of the invention. Curve 70 shows the relative marker concentration decrease for a double coated marker particle prepared according to the methods of the invention.

FIG. 6 is a graphic representation of the delayed decrease in marker concentration versus time for the preferred embodiments of the invention shown for the time between 0 and 5,000 hours. Curve 80 shows a relative marker decrease for an uncoated marker particle as known in the prior art. Curve 90 shows the relative marker concentration decrease for a single coated particle prepared pursuant to the methods of the invention. Curve 100 shows the relative marker concentration decrease for a double coated marker particle prepared according to the methods of the invention.

Although the invention has been described with reference to one or more preferred embodiments, this description is not to be construed in a limiting sense. There is modification of the disclosed embodiments, as well as alternative embodiments of this invention, which will be apparent to persons of ordinary skill in the art, and the invention shall be viewed as limited only by reference to the following claims.

1. A marker delivery particle for marking a reservoir comprising:
a means for marking the reservoir;
capsule surrounding the means for marking; and,
wherein the capsule operates to delay release of the means for marking into the reservoir.

2. The marker delivery particle of claim 1 wherein the capsule is selected from the group consisting essentially of cellulose acetate, polymers, cellulose ether, epicellulose, cellulose ester, polyvinyl, tetrafluorethylene, epoxy, phenolic resin and hydrophilic polymer.

3. The marker delivery particle of claim 2 wherein the proppant is added to a fracturing fluid.

4. The marker delivery particle of claim 1 wherein the capsule is a cellulosic material.

5. The marker delivery particle of claim 1 wherein the capsule comprises a single coating.

6. The marker delivery particle of claim 5, wherein the coating thickness is about 5-60 microns.

7. The marker delivery particle of claim 1 wherein the capsule comprises a multi-layered coating.

8. The marker delivery particle of claim 7 wherein the multi-layered coating is selected from the group consisting essentially of cellulose acetate, polymers, cellulose ether, epicellulose, cellulose ester, polyvinyl, tetrafluorethylene, epoxy, phenolic resin and hydrophilic polymer.

9. The marker delivery particle of claim 1 wherein the means for marking comprises a porous proppant saturated with a marker.

10. The marker delivery particle of claim 1 wherein the means for marking is a marker in particle form.

11. The marker delivery particle of claim 1, wherein the capsule is permeable to a fluid contained in the reservoir.

12. The marker delivery particle of claim 1 wherein the means for marking includes an oxidizing agent.

13. The marker delivery particle of claim 1, wherein the capsule is oil permeable.

14. The marker delivery particle of claim 1, wherein the capsule is water permeable.

15. The marker delivery particle of claim 1, wherein the means for marking is selected from the group consisting essentially of triflourobenzene, rhodamine, flourobenzoic acids, polynuclear aromatic hydrocarbons, halogenated hydrocarbons, colorants and a chemical where the molecular weight is enhanced.

16. The marker delivery particle of claim 1, wherein the means for marking is radioactive.

17. The marker delivery particle of claim 15, wherein the halogenated hydrocarbons are selected from the group consisting essentially of 1,2-diphenylbenzene; 1,4-diphenylbenzene, triphenylmethane, 1,3,5-triphenylbenzene, 1,1,2-triphenylethylene; tetraphenylethylene, 1,2,3,4-tetrahydrocarbazole, 1,3-diphcnylacetone, 2-chlorobenzophenone; 4,4-dichlorobenzophenone, 4-benzoylphenone, 4-bromobenzophenone, 4-methoxybenzophenone, 4-methylbenzophenone, 9-fluorenone, 1-phenylnaphthalene, 3,3 dimethoxybiphenyl, and 9-phenylanthracene.

18. The marker delivery particle of claim 15 wherein the chemical comprises an isotope of organic compounds selected from the group consisting essentially of acetone, acetonitrile, benzene, bromobenzene, chlorobenzene, chloroform, cyclohexane, dichlorobenzene, trichloroethylene, diethylether, diglyme, dimethylsulfoxide, dioxane, ethanol, methanol, methylene chloride, nitrobenzene, octane, pyridine, tetrachloroethane, tetrahydrofuran, tetrametholsilane, toluene, trifluoroacetic acid, trifluoroethyl alcohol, xylene, ammonium bromide, and acetyl chloride.

19. The marker delivery particle of claim 15 wherein the molecular weight of the chemical is artificially enhanced by the addition of a deuterium atom.

20. The marker delivery particle of claim 1 wherein a delay of release a marker in the means for marking is due to the permeability of the capsule.

21. The marker delivery particle of claim 1 wherein a delay of release of a marker in the means for marking is due to the rupture of the capsule.

22. A method for making a particle marker batch comprising the steps of:
selecting a particulate marker;
encapsulating the marker with a coating; and
drying the coating.

23. The method of claim 22 wherein the step of drying occurs at about 42° C.

24. The method of claim 22 comprising the further step of sorting the batch for approximately uniform size.

25. The method of claim 24 wherein the uniform size is between about 0.05 and 500 mg.

26. The method of claim 24 wherein the step of sorting comprises the step of sifting the batch.

27. The method of claim 24 wherein the step of sorting comprises the steps:
sifting the batch through a 10/20 mesh screen.

28. The method of claim 22 wherein the step of coating is repeated, thereby forming a multi-layered coating.

29. The method of claim 28 wherein the method further includes the step of sifting the multi-layered encapsulation first with about 50/80 mesh screen.

30. The method of claim 22 wherein the coating is crushable.

31. The method of claim 22 wherein the coating is a single layer coating.

32. The method of claim 31 wherein the coating is an oil permeable material.

33. The method of claim 31 wherein the coating is a water permeable material.

34. The method of claim 22 wherein the coating is selected from the group consisting essentially of cellulose acetate, polymers, cellulose ether, epicellulose, cellulose ester, polyvinyl, tetrafluorethylene, epoxy, phenolic resin and hydrophilic polymer.

35. The method of claim 22 wherein the coating thickness is about 5-60 microns.

36. The method of claim 22 wherein the marker is radioactive.

37. The method of claim 22 wherein the marker is selected from the group consisting essentially of triflourobenzene, rhodamine, flourobenzoic acids, polynuclear aromatic hydrocarbons, halogenated hydrocarbons, colorants, and non-radioactive marking means where the molecular weight of the molecule is artificially enhanced.

38. The method of claim 37 wherein the halogenated hydrocarbons are selected from the group consisting essentially of 1,2-diphenylbenzene; 1,4-diphenylbenzene, triphenylmethane, 1,3,5-triphenylbenzene, 1,1,2-triphenylethylene; tetraphenylethylene, 1,2,3,4-tetrahydrocarbazole, 1,3-diphcnylacetone, 2-chlorobenzophenone; 4,4-dichlorobenzophenone, 4-benzoylphenone, 4-bromobenzophenone, 4-methoxybenzophenone, 4-methylbenzophenone, 9-fluorenone, 1-phenylnaphthalene, 3,3 dimethoxybiphenyl, and 9-phenylanthracene.

39. The method of claim 37 wherein the marker comprises an isotope of organic compounds selected from the group consisting essentially of acetone, acetonitrile, benzene, bromobenzene, chlorobenzene, chloroform, cyclohexane, dichlorobenzene, trichloroethylene, diethylether, diglyme, dimethylsulfoxide, dioxane, ethanol, methanol, methylene chloride, nitrobenzene, octane, pyridine, tetrachloroethane, tetrahydrofuran, tetrametholsilane, toluene, trifluoroacetic acid, trifluoroethyl alcohol, xylene, ammonium bromide, and acetyl chloride.

40. The method of claim 37 wherein the molecular weight of the marker is artificially enhanced by the addition of a deuterium atom

41. The method of claim 24 wherein the uniform size is about 200 mg.

42. The method of claim 24 wherein the uniform size is above 0.5 mg.

43. The method of claim 24 wherein the uniform size is below about 500 mg.

44. The method of claim 22 wherein the step of encapsulating comprises:
spreading a batch of particles onto a processing pan;
covering the batch of particles with a cellulosic material; and, mixing the cellulosic material and particle batch, thereby ensuring coverage of each particle.

45. The method of claim 44 wherein the cellulosic material is selected from the group consisting essentially of liquid cellulose acetate, polymers, cellulose ether, epicellulose, cellulose ester, polyvinyl alcohol, and polytetrafluoroethylene.

46. The method of claim 22 wherein the step of encapsulating comprises use of a fluidized bed process.

47. A marker system for marking a reservoir fluid comprising:
a marker;
a porous proppant saturated with the marker; and
a coating covering the porous proppant.

48. The marker system of claim 47 wherein the porous proppant is selected from the group consisting essentially of porous ceramic beads, diatomaceous earth, walnut shells, aluminum pellets and sand grains.

49. The marker system of claim 47 wherein the mesh size of the coating is in the range of about 10/20 mesh to 40/70 mesh.

50. The marker system of claim 47 wherein the coating has a pore size of about 16/40 mesh.

51. The marker system of claim 47 wherein the coating has a mesh size of at least 35 mesh.

52. The marker system of claim 47 wherein the marker is selected from the group consisting essentially of triflourobenzene, rhodamine, flourobenzoic acids, polynuclear aromatic hydrocarbons, halogenated hydrocarbons, and non-radioactive marking means where the molecular weight of the molecule is artificially enhanced.

53. The marker system of claim 52 wherein the halogenated hydrocarbons are selected from the group consisting essentially of 1,2-diphenylbenzene; 1,4-diphenylbenzene, triphenylmethane, 1,3,5-triphenylbenzene, 1,1,2-triphenylethylene; tetraphenylethylene, 1,2,3,4-tetrahydrocarbazole, 1,3-diphcnylacetone, 2-chlorobenzophenone; 4,4-dichlorobenzophenone, 4-benzoylphenone, 4-bromobenzophenone, 4-methoxybenzophenone, 4-methylbenzophenone, 9-fluorenone, 1-phenylnaphthalene, 3,3 dimethoxybiphenyl, and 9-phenylanthracene.

54. The marker system of claim 52 wherein the marker comprises an isotope of organic compounds selected from the group consisting essentially of acetone, acetonitrile, benzene, bromobenzene, chlorobenzene, chloroform, cyclohexane, dichlorobenzene, trichloroethylene, diethylether, diglyme, dimethylsulfoxide, dioxane, ethanol, methanol, methylene chloride, nitrobenzene, octane, pyridine, tetrachloroethane, tetrahydrofuran, tetrametholsilane, toluene, trifluoroacetic acid, trifluoroethyl alcohol, xylene, ammonium bromide, and acetyl chloride.

55. The marker system of claim 47 wherein the marker is a triflourobenzoic acid.

56. The marker system of claim 47 wherein the marker is a flourobenzoate salt.

57. The marker system of claim 47 wherein the coating is an epoxy.

58. The marker system of claim 47 wherein the coating is a phenolic resin.

59. The marker system of claim 47 wherein the coating is a hydrophilic polymer.

60. The method of claim 47 wherein the coating is a permeable coating.

61. The method of claim 47 wherein the coating is crushable.

62. A method for using a marker system in a well comprising the steps of:
selecting a particulate marker;
encapsulating the marker with a coating;
drying the coating whereby a marker system is achieved;
injecting the marker system in the well;
allowing the well to produce a production fluid;
sampling production fluid; and,
analyzing the production fluid for presence of the marker.

63. The method of claim 62 wherein the steps of encapsulating and drying are repeated to produce a marker system with multiple coatings.

64. The method of claim 62 wherein the well includes a commingled reservoir with two or more zones.

65. The method of claim 64 wherein the step of analyzing includes analyzing a marker from each zone.

66. A method for using a marker system in a well comprising the steps of:
selecting a porous proppant;
saturating the porous proppant with a marker;
encapsulating the porous proppant with a coating;
drying the coating to create a marker system;
injecting the marker system in the well;
allowing the well to produce a production fluid;
sampling the production fluid; and
analyzing the production fluid for the presence of the marker.

67. The method of claim 62 wherein the steps of encapsulating and drying are repeated to produce a marker system with multiple coatings.

68. The method of claim 62 wherein the well includes a commingled reservoir with two or more zones.

69. The method of claim 64 wherein the step of analyzing included analyzing a marker from each zone.

70. A method of using a marker system which includes a coated marker coated in a well with two or more zones comprising the steps of:
injecting the coated marker in two or more zones;
allowing the zones to produce a production fluid;
sampling the production fluid; and
analyzing the production fluid for the presence of the coated marker in each zone.

71. The method of using a marker system of claim 70 including the further steps of
preparing a separate marker system to be used in each zone; and,
injecting a single unique marker system in each zone.
